(19) United States
(12) Patent Application Publication
(10) Pub. No.: US 2003/0110079 A1
(43) Pub. Date: Jun. 12, 2003

(54) Method and apparatus for providing items to users in a computer network

(76) Inventors: Mitchell T. Weisman, San Carlos, CA (US); Anthony G. Martin, Los Altos, CA (US); L. Scott Primak, San Jose, CA (US)

Correspondence Address: OKAMOTO & BENEDICTO, LLP, P.O. BOX 641330, SAN JOSE, CA, 95164, US

(21) Appl. No.: 10/021,737

(22) Filed: Dec. 12, 2001

(51) Int. Cl. G06F 17/60

(52) U.S. Cl. 705/14

(57) ABSTRACT

In one embodiment, items are designated as members of a group of items. The group of items are then made available to users. Users who have received any member item are provided additional items. Additional items are provided to a user who has received a member item, so long as the user retains any member item and regardless of whether the user is utilizing any member item. For example, advertising or promotional materials may be provided to a user so long as the user retains any member item which may include free or reduced-cost computer programs. The delivery of advertising or promotional materials may occur even if the user is not using any of the computer programs. In one embodiment, the advertising or promotional materials are delivered over the Internet.

### BACKGROUND OF THE INVENTION

1. Field Of The Invention

This invention relates generally to computer systems, and more particularly to methods and apparatus for providing items to users in a computer network.

2. Description Of The Background Art

Large public networks such as the Internet allow for relatively widespread and fast dissemination of information. On the Internet, for example, information on various topics may be obtained by a user having a computer and a web browser. Web sites for news, maps, educational materials, advertising, computer programs, coupons, services, telephony, music, products, pictures, movies, and other items are widely available on the Internet.

Advertising is a source of revenue for some Internet companies. For example, a web site operator may charge a certain amount to display advertising on a web site. An Internet service provider (ISP) may provide free or reduced cost Internet access in exchange for displaying advertising banners to its subscribers. Some companies deliver advertising via computer programs that are provided to users at no cost. Some of these free computer programs, also referred to as “shareware,” allow for delivery of advertising only while the shareware is being utilized. In some sharewares, the delivery of advertising is inextricably tied to a particular shareware; removal of the particular shareware ends the delivery of advertising.

### SUMMARY

The present invention relates to methods and apparatus for delivering items to users. The present invention may be used in a variety of applications including, by way of illustration and not limitation, in the delivery of advertising and promotional materials over the Internet.

In one embodiment, items are designated as members of a group of items. The group of items are then made available to users. Users who have received any member item are provided additional items. Additional items are provided to a user who has received a member item, so long as the user retains any member item and regardless of whether the user is utilizing any member item. For example, advertising or promotional materials may be provided to a user so long as the user retains any member item which may include free or reduced-cost computer programs. The delivery of advertising or promotional materials may occur even if the user is not using any of the computer programs.

These and other features and advantages of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of a computer network in accordance with an embodiment of the present invention.

FIG. 2 shows a schematic diagram of a client computer 101 in accordance with an embodiment of the present invention.

FIG. 3 shows a flow diagram of a method for providing items to users in accordance with an embodiment of the present invention.

The use of the same reference label in different drawings indicates the same or like components.

### DETAILED DESCRIPTION

In the present disclosure, numerous specific details are provided, such as examples of computers, components, computer programs, and/or methods, to provide a thorough understanding of embodiments of the invention. One skilled in the art will recognize, however, that the invention can be practiced without one or more of the specific details, or with other computers, components, computer programs, methods, and/or the like. In other instances, well-known details are not described to avoid obscuring aspects of the invention.

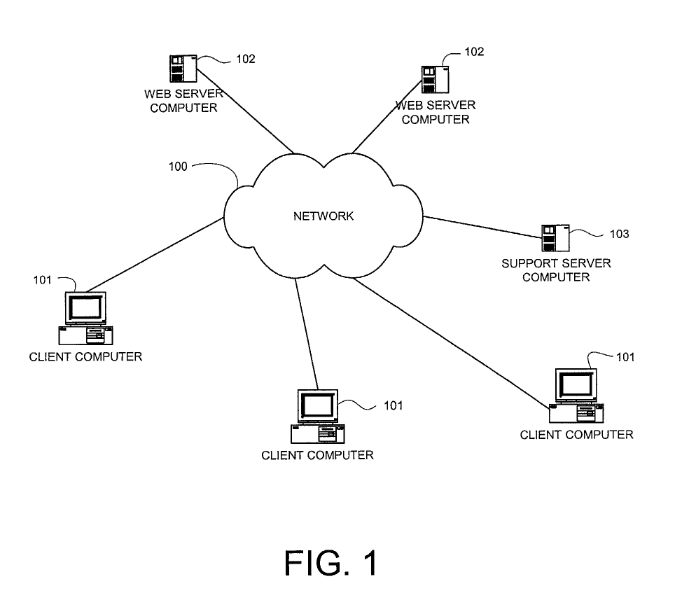

Referring now to FIG. 1, there is shown a schematic diagram of a computer network in accordance with an embodiment of the present invention. A network 100 includes one or more client computers 101, one or more web server computers 102, one or more support server computers 103, and other computers not shown. Intermediate nodes such as gateways, routers, bridges, Internet service provider networks, public-switched telephone networks, proxy servers, firewalls, etc. are not shown for clarity. In the embodiment of FIG. 1, network 100 includes the Internet; however, any type of computer network may also be used. Computers may be coupled to network 100 using any type of connection without detracting from the merits of the present invention.

A client computer 101 is typically, but not necessarily, a personal computer such as those running the Microsoft Windows™, Apple Macintosh™, Linux etc. operating systems. A user employs a suitably equipped client computer 101 to get on network 100 and access computers coupled thereto. For example, a client computer 101 may be used to access web pages from a web server computer 102. It is to be noted that the term “computer” includes any type of information processing device including personal digital assistants, digital telephones, wireless terminals, etc.

A web server computer 102 may be a web site containing information designed to attract users browsing on the Internet. A web server computer 102 may also include advertisements, downloadable computer programs, and products (i.e., goods and services) available for online purchase.

A support server computer 103 may also be a web site. Additionally, in one embodiment, a support server computer 103 includes files and downloadable computer programs for supporting, updating, or maintaining components on a client computer 101.

Web server computers 102 and support server computers 103 are typically, but not necessarily, server computers such as those available from Sun Microsystems, Hewlett-Packard, International Business Machines, etc. A client computer 101 communicates with a web server computer 102 or a support server computer 103 using client-server protocol. Client-server computing is well known in the art and will not be further described here.

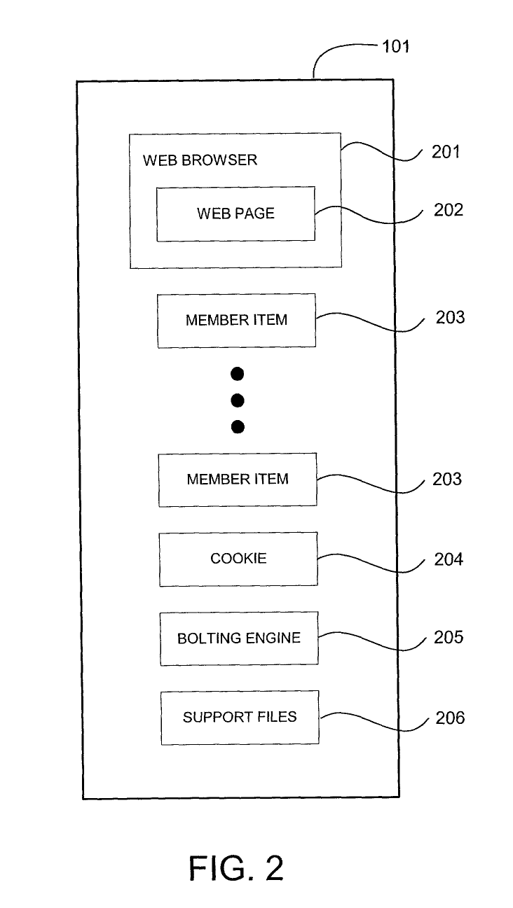

FIG. 2 shows a schematic diagram of a client computer 101 in accordance with an embodiment of the present invention. Client computer 101 includes the following components: a web browser 201, one or more member items 203, one or more cookies 204, bolting engine 205, and one or more support files 206. As can be appreciated, the components of client computer 101 may be implemented in software, hardware, firmware or combinations thereof. Additionally, the components of client computer 101 may be stored in a computer-readable storage medium such as a disk, and then loaded into a main memory for execution or processing by a microprocessor, for example.

Web browser 201 may be any type of web browser or web client. An example web browser 201 includes the Microsoft Internet Explorer™ web browser. Web browser 201 allows client computer 101 to get a web page 202 from a web server computer 102 or a support server computer 103. Web browser 201 also allows client computer 101 to receive cookies.

A member item 203 may be any item belonging to a group of items. As used in the present disclosure, the term “item” includes anything that may be provided to a user. By way of illustration and not limitation, an item may be a computer program, advertising vehicle, information, web site link, picture, wall paper, music, photography, video, executable file, data file, map, etc. An item may be received by a user over a computer network. For example, a computer program may be downloaded from a web server computer; similarly, an advertising pop-up may be received from a web server computer referred to as an “ad server”. An item may also be loaded from a removable computer-readable storage medium such as a floppy or optical disk. An item may also be a piece of hardware such as an add-on card.

In one embodiment, a member item 203 is an item that belongs to a group which allows for delivery of additional items to client computer 101. For example, a member item 203 may be a utility program downloaded free of charge or at reduced-cost from a web server computer 102. The utility program may be an electronic wallet such as that provided free of charge by The Gator Corporation (www.gator.com). In exchange for getting the utility program free of charge or at a reduced-cost, the user agrees to allow the developer or provider of the utility program to deliver additional items to client computer 101. By way of illustration and not limitation, the additional items may include advertising or promotional materials such as other computer programs, electronic coupons, web site access, wall papers, coupons, web site links, banners, pop-ups etc. The additional items may or may not be provided free of charge or at a reduced-cost. In essence, the advertising or promotional materials pay for the creation and maintenance of the utility program.

A member item 203 may belong to an advertising group. For example, different member items 203 may be from different vendors who formed a partnership. Once any member item 203 is installed in a client computer 101, all vendors may share in revenue arising from the subsequent delivery of advertising or other promotional materials. Revenue sharing may also be setup such that only vendors whose member item 203 is installed in a client computer 101 receive a share of the revenue.

A member item 203 may be identified by listing it in a support file 206 when the member item 203 is received in a client computer 101. If the member item 203 is a computer program, the computer program may be identified by naming it's executable files a certain way. A computer program may also include computer-readable program code for communicating with a bolting engine 205. Once the computer program is installed, it may alert bolting engine 205 of its presence. In response, bolting engine 205 may update a list of detected member items 203 in a support file 206. Bolting engine 205 may also inform a support server computer 103 of the computer program's presence in client computer 101. This allows support server computer 103 to update a cookie 204, which may also include a list of detected member items 203.

A hardware member item 203 may be identified by embedding an identification code in its firmware or BIOS, for example. A bolting engine 205 may scan expected input/output (I/O) addresses for the presence of a member item 203 in a client computer 101.

In one embodiment, a cookie 204 may be any cookie available through a web browser 201. For example, a cookie 204 may be a text file created by support server computer 103 to list member items 203 detected in client computer 101. When web browser 201 is pointed to support server computer 103, support server computer 103 reads cookie 204 to determine if any member item 203 is in client computer 101. If so, support server computer 103 may proceed to deliver additional items such as advertising to client computer 101.

In one embodiment, bolting engine 205 includes computer-readable program code for detecting member items 203 and for allowing delivery of additional items to client computer 101. Bolting engine 205 may include a download manager for downloading files, a client-server interface for communicating with a support server computer 103, and a browser application programming interface (API) for communicating with a web browser 201. Bolting engine 205 is not inextricably tied to any particular member item 203. That is, bolting engine 205 will function and continue to deliver other additional items such as advertising or promotional materials so long as any member item 203 is in client computer 101. Additionally, bolting engine 205 is a stand-alone computer program and is independent of any member item 203. Bolting engine 205 will deliver additional items to client computer 101 even if no member item 203 is currently in use. Bolting engine 205 only requires the presence of any member item 203 in client computer 101 to operate. Bolting engine 205 initiates the delivery of additional items once it detects a member item 203.

In one embodiment, bolting engine 205 receives advertising delivery vehicles from support server computer 103. When a member item 203 is downloaded from support server computer 103, support server computer 103 updates a cookie 204 to indicate that a member item 203 is in client computer 101. If any member item 203 is in client computer 101, support server computer 103 will deliver advertising vehicles such as pop-ups and banners to bolting engine 205, which then displays the advertising vehicles for viewing by the user.

In one embodiment, bolting engine 205 informs support server computer 103 of the presence of member items 203 in client computer 101. This triggers support server computer 103 to deliver advertising to client computer 101.

In one embodiment, the advertising delivered to client computer 101 includes targeted advertising (or other types of messages). For example, the advertising provided to a user may be selected based on a web page visited or currently being viewed by a user. This may be accomplished by having bolting engine 205 detect the uniform resource locator (URL) of the web page using a browser API command. The URLs of web pages visited by the user may be stored in a cache for later retrieval and comparison purposes. In one embodiment, support server computer 103 includes a database that categorizes the popular domains on the Internet. For example, support server computer 103 may categorize the domain “www.bookstore.com” as relevant to books, “www.dealership.com” as relevant to cars, “www.sportspage.com” as relevant to sports, etc. When a user points her browser to a web page, bolting engine 205 may inform support server computer 103 of the URL of the web page. Support server computer 103 may then search its database for a domain name matching the URL of the web page. If there is a match, support server computer 103 may then send bolting engine 205 an advertising vehicle relevant to the web page. For example, if the web page belongs to the domain “www.bookstore.com”, support server computer 103 may then send a book-related advertising to bolting engine 205 for display to the user. Support server computer 103 may also send advertising on behalf of a competitor of a company whose web page or product advertising is being viewed by the user. In the aforementioned bookstore example, support server computer 103 may also send bolting engine 205 advertising on behalf of a competitor of www.bookstore.com. Other targeted advertising techniques may also be used without detracting from the merits of the present invention. Additionally, messages other than advertising may also be sent by support server computer 103 to bolting engine 205.

In one embodiment, a support file 206 is a text file for maintaining a list of detected member items 203 in client computer 101 and for storing configuration settings.

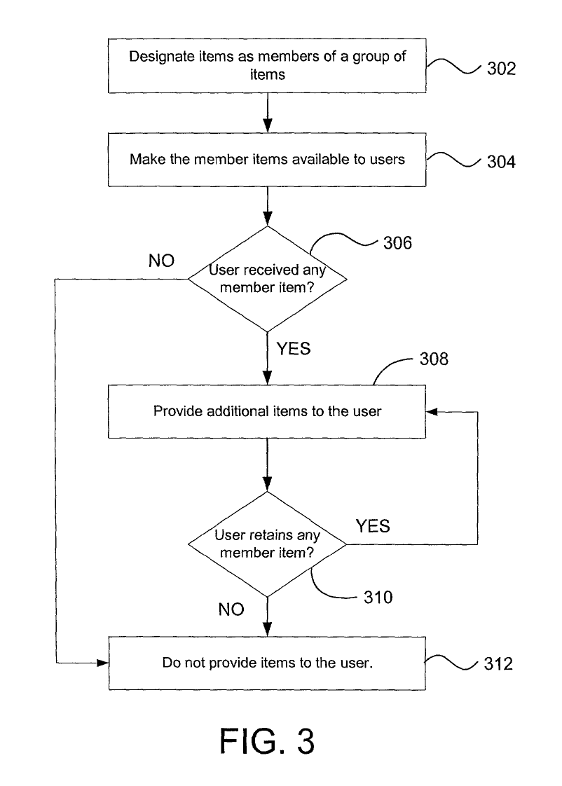

FIG. 3 shows a flow diagram of a method for providing items to users, according to an embodiment of the present invention. In action 302, one or more items are designated as members of a group of items. For example, a utility program downloadable from a web server computer may be designated as a member of an advertising group. Vendors of member items belonging to the advertising group may share revenues arising from the delivery of additional items to users.

In action 304, member items are made available to users. For example, member items such as utility programs, digital photos, electronic coupons, etc. may be made available for download over a computer network such as the Internet. A User License Agreement may be provided to users who wish to receive a member item. Users may be required to acknowledge and agree to the User License Agreement prior to receiving any member item. An example User License Agreement may include the following language:

PLEASE READ THIS USER LICENSE AGREEMENT CAREFULLY AND MAKE SURE YOU UNDERSTAND IT. IT GOVERNS ANYTHING YOU CHOOSE TO RECEIVE FROM US, OR THIRD PARTIES, IN EXCHANGE FOR YOUR ALLOWING US TO BRING YOU ITEMS LIKE ADVERTISEMENTS, INFORMATION, AND SOFTWARE (COLLECTIVELY “MEMBER ITEMS”). YOU ARE BEING OFFERED, AND WILL RECEIVE, MEMBER ITEMS ONLY IF YOU ACCEPT THIS USER LICENSE AGREEMENT. IT CONTAINS IMPORTANT INFORMATION THAT YOU SHOULD KNOW BEFORE USING MEMBER ITEMS. THIS USER LICENSE AGREEMENT REPLACES ANY PREVIOUS VERSIONS THAT YOU MAY HAVE AGREED TO.

YOU MAY TERMINATE THIS USER LICENSE AGREEMENT AT ANY TIME BY UNINSTALLING ALL MEMBER ITEMS FROM YOUR COMPUTER USING THE ADD/REMOVE PROGRAMS MENU IN YOUR MICROSOFT (R) WINDOWS (R) CONTROL PANEL, AND DESTROYING ANY OTHER COPIES OF MEMBER ITEMS YOU MAY HAVE MADE . . .

In actions 306 and 312, items are not provided to users who have not received any member item. For example, a user who has not downloaded any member item will not receive advertising. In actions 306 and 308, additional items are provided to users who have received a member item. For example, a user who has downloaded a member utility program will receive advertising from a support server computer 103 via bolting engine 205. Note that a user who has received a member item will receive additional items such as advertising or promotional materials regardless of whether the user is currently using any member item. As can be appreciated, delivery of advertising even if the user is not currently using any member item advantageously allows for more opportunity to advertise. This is a break from the old convention of making advertising delivery dependent on the use of a particular item.

In actions 310 and 308, additional items are provided to users who have retained any member item. In the present invention, delivery of additional items is not inextricably tied to any particular member item. For example, a first member item from a web server computer may be downloaded to a client computer. The downloading of the first member item triggers the delivery of additional items to the client computer. At some point in time, a second member item may be downloaded from another web server computer. As long as any member item is still present in the client computer, whether it is the first or the second member item, additional items may be delivered to the client computer. As can be appreciated, not tying the delivery of advertising to any particular member item results in a flexible advertising delivery platform. The provider of advertising does not have to rely on any specific item to be able to provide advertising to users. Additionally, additional member items may be included in a group of items without having to update a bolting engine 205. This facilitates the addition of other member items in an advertising group.

In one embodiment, the user's permission is obtained before any additional item other than advertising is provided to the user in action 308. For example, the user's permission may be required before installing and activating new computer programs in the user's computer.

In actions 310 and 312, additional items are not provided to users who have not retained any member item. That is, a user who has removed all member items from her computer will not receive additional items.

An improved technique for providing items to users has been disclosed. While specific embodiments have been provided, it is to be understood that these embodiments are for illustration purposes and not limiting. Many additional embodiments will be apparent to persons of ordinary skill in the art reading this disclosure. Thus, the present invention is limited only by the following claims.

What is claimed is:

1. A method of delivering advertising to users in a computer network, the method comprising:
designating a plurality of items as member items of a group;
making the member items available over the computer network;
downloading at least one member item to a computer; and
delivering advertising to the computer even if no member item is being utilized in the computer.

2. The method of claim 1 further comprising the act of delivering advertising to the computer so long as any member item remains in the computer.

3. The method of claim 1 wherein the member items include a computer program.

4. The method of claim 1 wherein the computer network includes the Internet.

5. The method of claim 1 further comprising the act of making a list of member items in the computer.

6. The method of claim 1 wherein the advertising is selected based on a web page viewed by a user of the computer.

7. A computer comprising:
an item provided in exchange for the right to deliver advertising to the computer;
computer-readable program code for detecting the item in the computer; and
computer-readable program code for delivering a piece of advertising to the computer so long as the item remains in the computer and regardless of whether the item is being used.

8. The computer of claim 7 wherein the item includes a computer program.

9. The computer of claim 7 wherein the item is provided over the Internet.

10. The computer of claim 7 further comprising a list of member items present in the computer.

11. The computer of claim 7 wherein the piece of advertising is displayed in a pop-up.

12. The computer of claim 7 wherein the piece of advertising includes targeted advertising.

13. The method of claim 7 wherein the piece of advertising is on behalf of a competitor of a company whose web page is being viewed by a user.

14. A method of providing items to users comprising:
designating any member of a group of items as a member item;
making one or more member items available to a user;
providing at least one member item to the user; and
providing additional items to the user so long as the user retains at least one member item and regardless of whether the user is utilizing any member item.

15. The method of claim 14 wherein the group of items includes a computer program as a member item.

16. The method of claim 14 wherein the additional items include a message selected for delivery to a computer of the user based on a web page visited by the user.

17. The method of claim 14 wherein the additional items include advertising relevant to a web page being viewed by the user.

18. The method of claim 14 wherein the additional items include advertising provided on behalf of a competitor of a company whose web page is being viewed by the user.

19. The method of claim 14 wherein the additional items include advertising provided on behalf of a company whose product is of the same type as a competitor's product advertised over the Internet.

20. The method of claim 14 wherein the additional items include a computer program.

21. The method of claim 14 wherein member items of the group of items are available over the Internet.

22. The method of claim 14 wherein the group of items includes an advertising group.
